(19) United States
(12) Patent Application Publication
(10) Pub. No.: US 2024/0041149 A1
(43) Pub. Date: Feb. 8, 2024

(54) PROTECTIVE ARTICLE AND A METHOD OF FORMING A PROTECTIVE ARTICLE

(71) Applicant: NATIONAL UNIVERSITY OF SINGAPORE, Singapore (SG)

(72) Inventors: Leong Hien Poh, Singapore (SG); Balaji Vengatachalam, Singapore (SG)

(21) Appl. No.: 18/266,626

(22) PCT Filed: Dec. 10, 2021
(86) PCT No.: PCT/SG2021/050777

§ 371 Date: Jun. 12, 2023

(30) Foreign Application Priority Data
Dec. 15, 2020 (SG) 10202012542V
Mar. 19, 2021 (SG) 10202102840Q

(51) Int. Cl. A42B 3/12; B29C 45/26

(52) U.S. Cl. CPC A42B 3/124; B29C 45/2624; B29L 2031/7172

(57) ABSTRACT

A protective article is described. The protective article comprises auxetic structures including: (i) a first auxetic structure having a first auxetic plane exhibiting auxetic behaviour and a first auxetic structure axis, the first auxetic structure axis being substantially perpendicular to the first auxetic plane; and (ii) a second auxetic structure having a second auxetic plane exhibiting auxetic behaviour and a second auxetic structure axis, the second auxetic structure axis being substantially perpendicular to the second auxetic plane. The second auxetic structure axis is arranged in a non-parallel relationship to the first auxetic structure axis. An auxetic structure for use in a protective article and a method for forming the auxetic structure are also described.

### TECHNICAL FIELD

The present disclosure relates to a protective article and a method of forming a protective article.

### BACKGROUND

People who have been exposed to Traumatic Brain Injuries (TBIs) have a greater chance of reinjury, developing cognitive slowing and chronic traumatic encephalopathy (CTE), and showing early onset of Alzheimer's disease. 3.8 million cases of TB's have been documented every year in the United States alone with a significant portion of which arising from sports and recreation related activities. As the world becomes increasingly health conscious, it is conceivable that the number of youth and adolescent participants in sports will continue to grow, with a corresponding increase in incidences of TBIs.

A most common form of personal protective equipment used to protect the head and brain from injury is a helmet. A conventional helmet comprises an acrylonitrile butadiene styrene (ABS) plastic shell lined with crushable expanded polystyrene (EPS) liners which function to absorb any impacts experienced by the helmet. A conventional helmet is thus primarily designed to protect the skull from fractures during an accident. However, the brain is extremely sensitive to rotational impact forces transmitted to the head in the event of an oblique impact, i.e., when the helmet impacts the ground at an inclined angle, and these rotational impacts cannot be reduced by crushable EPS liners in a conventional helmet. Although a conventional helmet can save an athlete from fatal brain injuries, it does not protect the athlete from TB's resulted from severe linear and rotational accelerations experienced by the athlete's head upon impact, which cause brain bleeding, concussions and diffuse axonal injuries. The severe linear and rotational accelerations induce shearing forces which produce a devastating effect on the brain cells and result in life altering TBIs.

Current state-of-the-art helmet technology that is commercially available predominantly includes a standard high strength plastic outer shell lined with a thick layer of crushable foam material which is typically made of polyurethane. Most of these state-of-the-art helmet technologies either provide a linear or a rotational acceleration reduction. Examples of current technologies used for linear force reduction includes the use of a collapsible honeycomb layer, and that for rotational acceleration reduction includes the use of a slip layer, a shear pad inner lining, a multi-directional damping system and a low-density layer. However, these technologies either provide a linear or a rotational force reduction and are therefore insufficient to reduce the often severe linear and rotational accelerations produced on the athlete's head upon impact. This is evident as the number of TB's documented in relation to sporting injuries has not reduced despite of these developments. Recently, a combination of technologies to provide both linear and rotational force reductions has been introduced in helmets. However, implementation of a combination of these two types of technologies requires a complicated helmet architecture, and even if such complicated helmet architecture is designed and produced, this adds significant weight to the helmet which is undesirable.

It is therefore desirable to provide a protective article and a method of forming a protective article which address the aforementioned problems and/or provides a useful alternative. Further, other desirable features and characteristics will become apparent from the subsequent detailed description and the appended claims, taken in conjunction with the accompanying drawings and this background of the disclosure.

### SUMMARY

Aspects of the present disclosure relate to a protective article and a method of forming a protective article. Particularly, aspects of the present disclosure relate to a protective article comprising auxetic structures, an auxetic structure for use in a protective article and a method of forming the auxetic structure.

In accordance with a first aspect, there is provided a protective article comprising auxetic structures, the auxetic structures include: a first auxetic structure having a first auxetic plane exhibiting auxetic behaviour and a first auxetic structure axis, the first auxetic structure axis being substantially perpendicular to the first auxetic plane; and a second auxetic structure having a second auxetic plane exhibiting auxetic behaviour and a second auxetic structure axis, the second auxetic structure axis being substantially perpendicular to the second auxetic plane, wherein the second auxetic structure axis is arranged in a non-parallel relationship to the first auxetic structure axis.

By including auxetic structures where the first auxetic structure and the second auxetic structure are arranged so that the second auxetic structure axis is in a non-parallel relationship to the first auxetic structure axis, the protective article, when lined for example in a helmet or other protective gear, provides a multi-directional protection for reducing both linear and rotational accelerations. The auxetic structures used in the protective article provide effective absorption of any external impact forces due to their auxetic natures, which are characterised by negative Poisson's ratios. Generally, a negative Poisson's ratio means that an auxetic structure or material contracts laterally under compression. This characteristic of an auxetic structure enables it to display high energy absorbing characteristics. Further, protective articles comprising auxetic structures can be customised and designed for use in collapsible liners to replace EPS liners in a conventional helmet, without increasing a size of the helmet while providing the added protections. These collapsible liners may be standalone liners which can be integrated into all categories of helmets (e.g. sports, motorcycle/motocross and safety helmets etc.). In addition, the multi-directional protection provided will also satisfy rotational tests which will be introduced in the new Economic Commission for Europe (ECE) Standards (version 22.06) for motorcycle helmets. Still further, the protective article used as crushable liners can be designed to minimise hindrance to a helmet's ventilation and to provide an overall thinner and/or lighter helmet.

The first auxetic structure axis may be an axis of extrusion of the first auxetic structure, and the second structure axis may be an axis of extrusion of the second auxetic structure.

The first auxetic structure axis may be perpendicular to the second auxetic structure axis. By incorporating this feature, the first auxetic plane is substantially orthogonal or orthogonal to the second auxetic plane and this allows the protective article to provide effective protection against impacts from an encompassing range of directions.

The first auxetic structure and the second auxetic structure may made of different auxetic geometries. The first auxetic structure and the second auxetic structure may also be made of different material compositions. These allow the first and second auxetic structures to be customised and designed according to their applications and needs.

The first auxetic structure and the second auxetic structure may each comprise an auxetic geometry selected from a wavy chiral geometry, a re-entrant auxetic geometry, or a missing rib auxetic geometry.

In accordance with a second aspect, an auxetic structure for use in a protective article is described. The auxetic structure having an auxetic plane exhibiting auxetic behaviour and an auxetic structure axis, the auxetic structure axis being substantially perpendicular to the auxetic plane, the auxetic structure comprising a plurality of interconnected auxetic members, each auxetic member having a body extending along the auxetic structure axis, the body tapering from a proximal end to a distal end, wherein at least some adjacent auxetic members are arranged in opposite relations in which a distal end of one auxetic member is arranged adjacent to a proximal end of an adjacent auxetic member.

Having a tapered body for each of the auxetic member of the auxetic structure is particularly useful if the auxetic structure is to be formed using conventional mass-production manufacturing method such as injection moulding. By having at least some adjacent auxetic members arranged in opposite relations in which a distal end of one auxetic member is arranged adjacent to a proximal end of an adjacent auxetic member, moulds or features of a casting die for forming these members can also be arranged in an opposite manner so that ejection of these moulds can be in opposite directions. This helps in an ejection process for extracting the auxetic structure from the mould.

The at least some adjacent auxetic members may be arranged so that auxetic members in a row are in opposite relations to auxetic members in adjacent rows.

The at least some adjacent auxetic members may be arranged so that auxetic members in a column are in opposite relations to auxetic members in adjacent columns.

The at least some adjacent auxetic members may be arranged so that alternating adjacent auxetic members are in opposite relations to each other.

The body of each auxetic member may taper linearly from the proximal end to the distal end. The body of each auxetic member may taper at a draft angle of 2°.

The auxetic structure may be selected from a tetrachiral geometry or a hexachiral geometry.

In accordance with a third aspect, there is provided a method for forming any one of the preceding auxetic structure by injection moulding.

The injection moulding may comprise: (i) providing material for forming the auxetic structure in a die, the die having tapered features arranged in opposite relations for forming the at least some adjacent auxetic members of the auxetic structure; and ejecting the tapered features of the die in opposite directions to form the auxetic structure.

In accordance with a fourth aspect, there is provided a protective article comprising any one of the preceding auxetic structure.

In accordance with a fifth aspect, there is provided a head gear comprising any one of the preceding protective article.

The protective article may be adapted to line an interior of the head gear so that the first auxetic plane of the first auxetic structure and the second auxetic plane of the second auxetic structure are perpendicular to an outer surface of the head gear.

The protective article may be adapted to line an interior of the head gear so that the auxetic plane of the auxetic structure is perpendicular to an outer surface of the head gear.

In accordance with a sixth aspect, there is provided a fuel tank comprising any one of the preceding protective article.

### BRIEF DESCRIPTION OF DRAWINGS

Embodiments of the disclosure will now be described, by way of example only, with reference to the following drawings, in which:

FIGS. 1A and 1B are schematics showing behaviours of a non-auxetic material and an auxetic material under a localised impact, where FIG. 1A shows the behaviour of the non-auxetic material under a localised impact and FIG. 1B shows the behaviour of the auxetic material under a localised impact;

FIG. 2 shows an example of a two-dimensional wavy chiral auxetic geometry in accordance with an embodiment;

FIG. 3 shows an auxetic structure in three-dimensions having the wavy chiral geometry of FIG. 2 in accordance with an embodiment;

FIG. 4 shows a two-dimensional cross-section of the auxetic structure of FIG. 3 in accordance with an embodiment;

FIG. 5 shows an enlarged illustration of the cross-section of FIG. 4 in accordance with an embodiment;

FIG. 6 shows the auxetic structure of FIG. 3 where an auxetic structure axis is defined to be perpendicular to an auxetic plane which exhibits auxetic behaviour in accordance with an embodiment;

FIGS. 7A and 7B show sections of a head gear comprising a protective article including two auxetic structures of FIG. 3 being placed adjacent to each other in accordance with an embodiment, where FIG. 7A shows a cross-section of the head gear comprising a plastic shell lined with the protective article and FIG. 7B shows a blow-up schematic of the protective article comprising the two auxetic structures stacked adjacent to each other;

FIG. 8 shows a schematic of two auxetic structures stacked one on top the other to form the protective article of FIG. 7A in accordance with an embodiment, where a first auxetic structure axis of a first auxetic structure is perpendicular to a second auxetic structure axis of a second auxetic structure;

FIG. 9 shows a schematic of the protective article of FIG. 7A when used as a liner in a helmet or a head gear in accordance with an embodiment, where the protective article is arranged so that the first and second auxetic structure axes of the protective article is substantially parallel to a surface plane of the helmet or the head gear;

FIG. 10 shows a schematic of a protective article used in a helmet or a head gear in accordance with an embodiment where at least one auxetic structures of the protective article includes a re-entrant auxetic geometry;

FIG. 11 shows a schematic of a protective article used in a helmet or a head gear in accordance with an embodiment where at least one auxetic structures of the protective article includes a missing rib auxetic geometry;

FIG. 12 shows a cross-section of a head gear comprising a protective article including auxetic structures during a direct impact in accordance with an embodiment;

FIG. 13 shows a cross-section of a head gear comprising a protective article including auxetic structures during an oblique impact in accordance with an embodiment;

FIG. 14 shows an image of a helmet or a head gear lined with a protective article comprising an auxetic structure in accordance with an embodiment;

FIG. 15 shows an image of an experimental drop-test set-up used in testing a direct impact and an oblique impact on a conventional helmet and the helmet of FIG. 14 in accordance with an embodiment;

FIGS. 16A and 16B show images of the helmet of FIG. 14 undergoing drop-tests in accordance with an embodiment, where FIG. 16A shows the image of a direct impact drop-test during which the helmet impacted on a flat anvil and FIG. 16B shows the image of an oblique impact drop-test during which the helmet impacted on an angled anvil;

FIG. 17 shows experimental results obtained from a direct impact drop-test experiment using a conventional helmet and the helmet of FIG. 14 in accordance with an embodiment;

FIGS. 18A and 18B show images illustrating rebound heights of the conventional helmet as well as the helmet of FIG. 14 used in the direct impact drop-test experiment in accordance with an embodiment, where FIG. 18A shows an image illustrating the rebound height of the conventional helmet after a direct impact and FIG. 18B shows an image illustrating the rebound height of the helmet of FIG. 14 after a direct impact;

FIG. 19 shows experimental results obtained from an oblique impact drop-test experiment using a conventional helmet and the helmet of FIG. 14 in accordance with an embodiment;

FIGS. 20A, 20B, 20C, 20D, 20E and 20F show illustrations of different auxetic geometries that exhibit auxetic behaviour in a x-y plane in accordance with embodiments, where FIG. 20A show a triangle geometry, FIG. 20B shows a missing rib hexachiral geometry, FIG. 20C shows a missing rib anti-tetra chiral geometry, FIG. 20D shows a straight chiral geometry, FIG. 20E shows a wavy chiral geometry and FIG. 20F shows a re-entrant geometry;

FIGS. 21A and 21B show schematics of a three-dimensional structure proposed to be formed by injection moulding in accordance with an embodiment, where FIG. 21A shows a perspective view of the three-dimensional structure and FIG. 21B shows a cross-sectional view of the three-dimensional structure;

FIGS. 22A and 22B shows schematics of a casting die tool used in injection moulding for forming the three-dimensional structure of FIG. 21A in accordance with an embodiment, where FIG. 22A shows a perspective view of the casting die tool and FIG. 22B shows an internal structure of the casting die tool;

FIG. 23 shows an internal structure of a casting die tool for forming the three-dimensional structure of FIG. 21A that is made suitable for ejection in injection moulding in accordance with an embodiment;

FIGS. 24A, 24B and 24C show illustrations of a final product of the three-dimensional structure of FIG. 21A formed by injection moulding using the casting die tool of FIG. 23 in accordance with an embodiment, where FIG. 24A shows a perspective view of the final product, FIG. 24B shows a cross-sectional view from a proximal end of the final product and FIG. 24C shows a cross-sectional view from a distal end of the final product;

FIG. 25 shows a perspective view of a three-dimensional hexachiral auxetic structure having a constant ring radius in accordance with an embodiment;

FIG. 26 shows a perspective view of a three-dimensional hexachiral auxetic structure with each member of the auxetic structure having a varying ring radius in a direction of the auxetic structure axis where auxetic members in adjacent rows taper in an opposite direction in accordance with an embodiment;

FIG. 27 shows a perspective view of portions of a casting die tool used in injection moulding for forming the three-dimensional hexachiral auxetic structure of FIG. 26 in accordance with an embodiment;

FIG. 28 shows a perspective view of a three-dimensional tetrachiral auxetic structure with each member of the auxetic structure having a varying ring radius in a direction of the auxetic structure axis where alternating auxetic members taper in opposite directions in accordance with an embodiment; and

FIG. 29 shows a top cross-sectional view of the portions of the casting die tool used in injection moulding for forming the three-dimensional tetrachiral auxetic structure of FIG. 28 in accordance with an embodiment.

### DESCRIPTION

The following description is merely exemplary in nature and is not intended to limit the disclosure or the application and uses of the disclosure. Furthermore, there is no intention to be bound by any theory presented in the preceding background or the following description.

Exemplary embodiments relate to a protective article comprising auxetic structures, an auxetic structure for use in a protective article, and a method of forming an auxetic structure. Particularly, an auxetic structure or material belongs to a novel class of meta-materials which has a negative Poisson's ratio, characterised by its lateral contraction under compression and its expansion under tension. An auxetic structure or auxetic material therefore displays enhanced mechanical properties such as high energy absorbing characteristics, high indentation resistance and high fracture toughness, and can be exploited to be used in high performance protective articles. Further, mechanical properties of such an auxetic structure or material can be tailored to absorb impact energy and withstand localised impact loads, with a high strength to weight ratio for ease of handling and user comfort. This allows impact energy to be attenuated more effectively and efficiently and is thus useful in protective articles that can be applied to head gears and/or fuel tanks etc.

In an embodiment, there is provided a protective article comprising auxetic structures, the auxetic structures include: a first auxetic structure having a first auxetic plane exhibiting auxetic behaviour and a first auxetic structure axis, the first auxetic structure axis being substantially perpendicular to the first auxetic plane; and a second auxetic structure having a second auxetic plane exhibiting auxetic behaviour and a second auxetic structure axis, the second auxetic structure axis being substantially perpendicular to the second auxetic plane, wherein the second auxetic structure axis is arranged in a non-parallel relationship to the first auxetic structure axis. By including auxetic structures where the first auxetic structure and the second auxetic structure are arranged so that the second auxetic structure axis is in a non-parallel relationship to the first auxetic structure axis, the protective article, when lined for example in a helmet or other protective gear, provides multi-directional protection for reducing both linear and rotational accelerations.

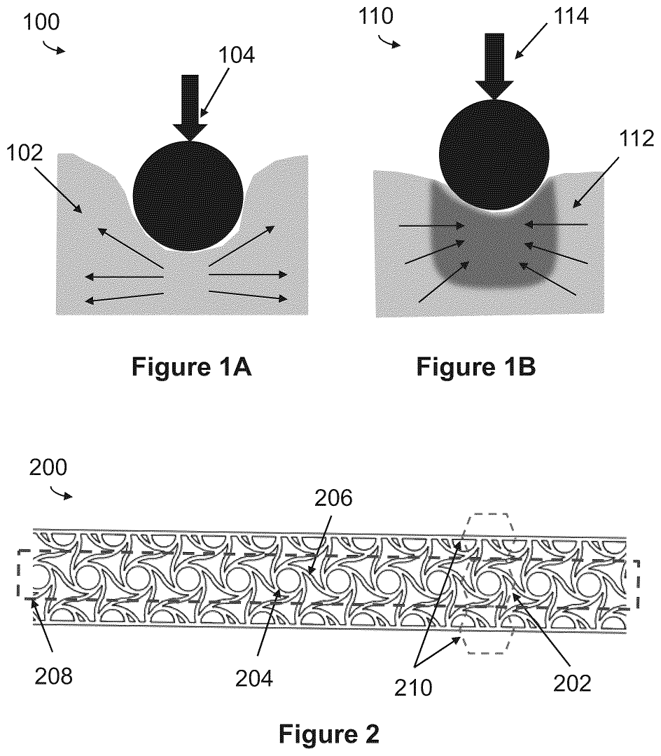

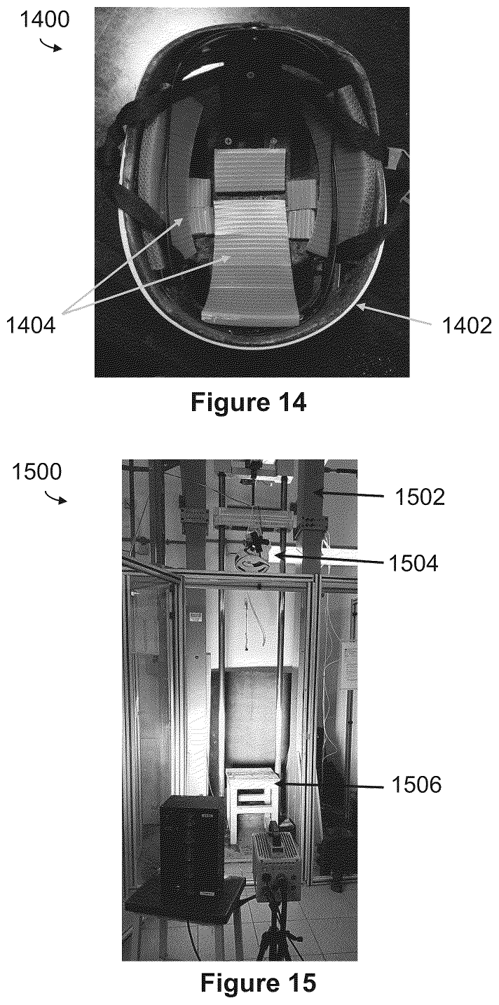

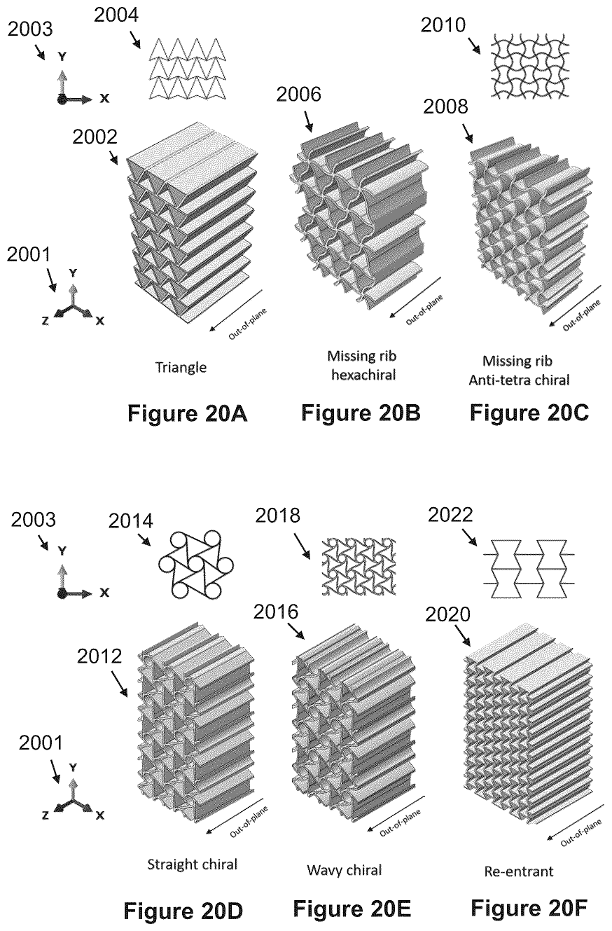

Details in relation to this embodiment of a protective article are described in relation to FIGS. 1 to 20F. In the present disclosure, an auxetic geometry including a wavy chiral auxetic geometry (e.g. a hexachiral auxetic with a central ring) is found to be effective in protection against both direct and oblique impacts. A protective article comprising an auxetic structure having the wavy chiral auxetic geometry was developed and used in a head gear or a helmet as auxetic collapsible liners. Such auxetic collapsible liners can be used to replace the conventionally used EPS liners, reducing linear acceleration (direct impact) and rotational acceleration (oblique impact) experienced by a user upon impact by 33% and 50%, respectively. Experimental results validating these are described in relation to FIGS. 14 to 19. Although the experimental results as shown are for a protective article comprising an auxetic structure, a skilled person would appreciate that similar if not better results can be achieved by using a protective article comprising auxetic structures as shown e.g. in FIG. 9. Other auxetic geometries that have been developed for impact energy absorption are shown in relation to FIGS. 20A to 20F.

In another embodiment, an auxetic structure having an auxetic plane exhibiting auxetic behaviour and an auxetic structure axis is described. The auxetic structure axis is substantially perpendicular to the auxetic plane. The auxetic structure comprises a plurality of interconnected auxetic members, each auxetic member having a body extending along the auxetic structure axis where the body tapers from a proximal end to a distal end. At least some adjacent auxetic members of the auxetic structure are arranged in opposite relations in which a distal end of one auxetic member is arranged adjacent to a proximal end of an adjacent auxetic member. Particularly, having a tapered body for each of the auxetic member of the auxetic structure is useful if the auxetic structure is to be formed using conventional mass-production manufacturing method such as injection moulding. By having at least some adjacent auxetic members arranged in opposite relations in which a distal end of one auxetic member is arranged adjacent to a proximal end of an adjacent auxetic member, moulds or features of a casting die used e.g. in injection moulding for forming these members can be arranged in an opposite manner so that ejection of these moulds can be in opposite directions. This helps in an ejection process for extracting the auxetic structure from the mould.

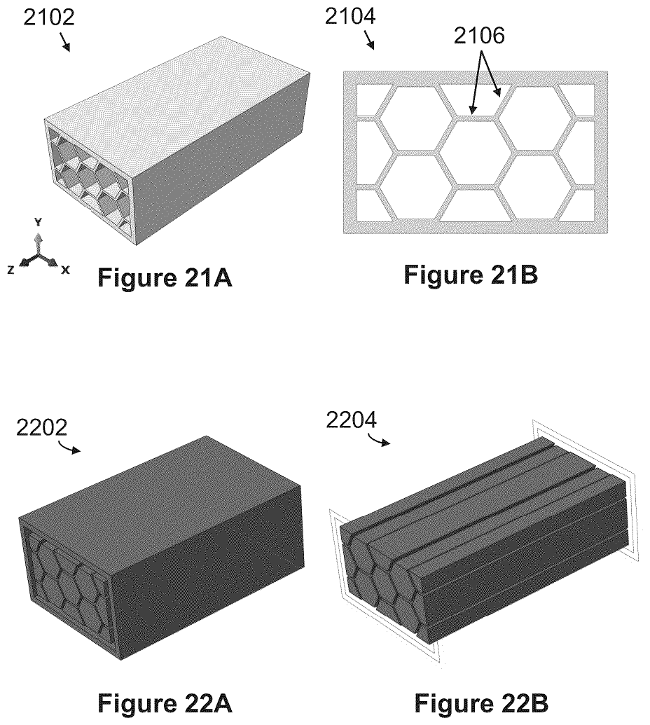

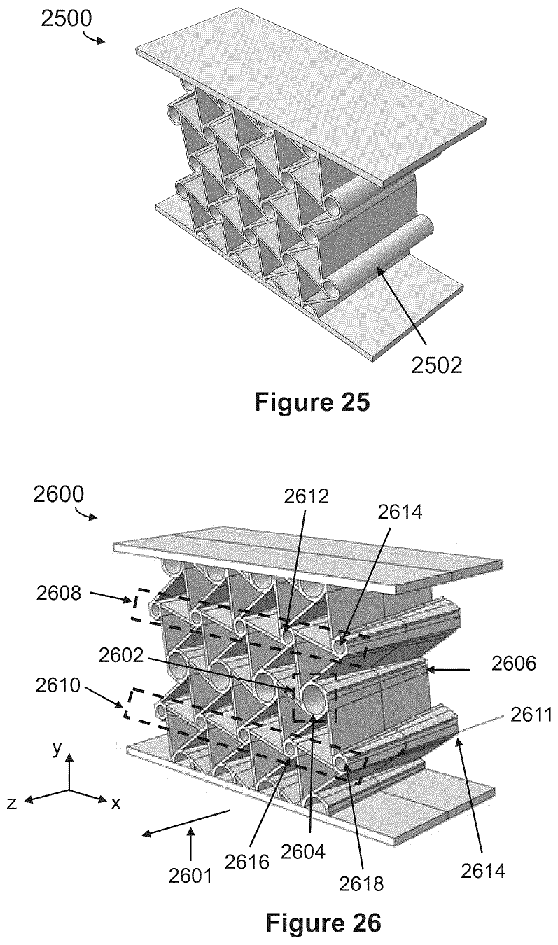

Details in relation to this embodiment of the auxetic structure are described in relation to FIGS. 21A to 29. FIGS. 21A to 24C illustrates issues typically faced in injection moulding, and FIGS. 25 to 29 describes embodiments of an auxetic structure for solving the issues faced with respect to injection moulding.

FIGS. 1A and 1B are schematics 100, 110 showing behaviours of a non-auxetic material 102 and an auxetic material 112 under a localised impact 104, 114. FIG. 1A shows the behaviour of the non-auxetic material 102 under the localised impact 104, while FIG. 1B shows the behaviour of the auxetic material 112 under the localised impact 114. As shown in FIG. 1A, under the localised impact 104 or compression, the non-auxetic material 102 expands, stretches and thins out at the point of impact. In contrast, as shown in FIG. 1B, the auxetic material 112 or structure has a negative Poisson's ratio and exhibits auxetic behaviour where the auxetic material or structure laterally contracts under compression.

FIG. 2 shows an example of a two-dimensional auxetic geometry, a wavy hexachiral geometry 200, in accordance with an embodiment. Particularly as shown in FIG. 2, each member 202 of the wavy hexachiral geometry includes a ring 204 in the middle connected to six wavy arms or ligaments 206. In this wavy hexachiral geometry 200, each member 202 is connected to six adjacent members. Two of these six adjacent members are in a same row 208, while the other four 210 of these six adjacent members are in adjacent rows.

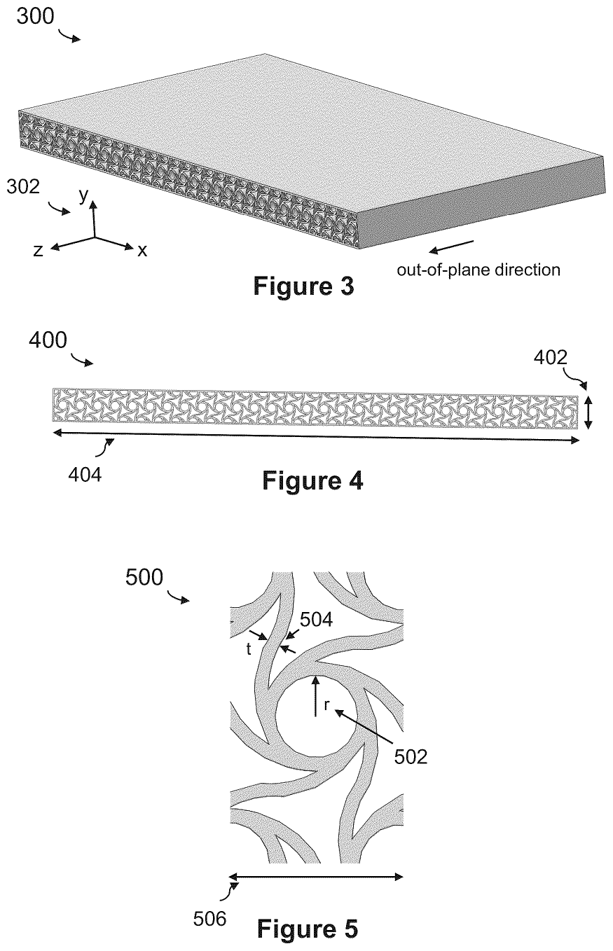

FIG. 3 shows a three-dimensional (3D) auxetic structure 300 having the wavy chiral geometry 200 of FIG. 2, in accordance with an embodiment. As shown in FIG. 3, the 3D auxetic structure 300 has a constant cross-section across an out-of-plane (z) direction. The Cartesian coordinates 302 with reference to the auxetic structure 300 is shown in FIG. 3. This 3D auxetic structure 300 can be used as an auxetic liner in, for example, a head gear or a helmet, or a fuel tank. Although only two/three rows of wavy hexachiral members are shown, it should not be considered limiting as such. A skilled person in the art will appreciate that an auxetic structure in a protective article can include more rows as necessary.

FIG. 4 shows a two-dimensional cross-section 400 of the 3D auxetic structure 300 of FIG. 3, in accordance with an embodiment. The cross-section 400 as shown represents the cross-section in the x-y plane of the auxetic structure 300. In the present embodiment (not to scale), a height 402 of the auxetic structure 300 is 10 mm while a width 404 of the auxetic structure 300 is 150 mm.

FIG. 5 shows an enlarged illustration 500 of the two-dimensional auxetic geometry 400 of FIG. 4 in accordance with an embodiment. FIG. 5 (not to scale) shows a member or a unit cell of the two-dimensional auxetic geometry 400. In the present embodiment, a ring of the unit cell has a radius (r) 502 of 2 mm, and each ligament of the unit cell has a thickness (t) 504 of 0.4 mm. Each unit cell also spans a width 506 of 5 mm.

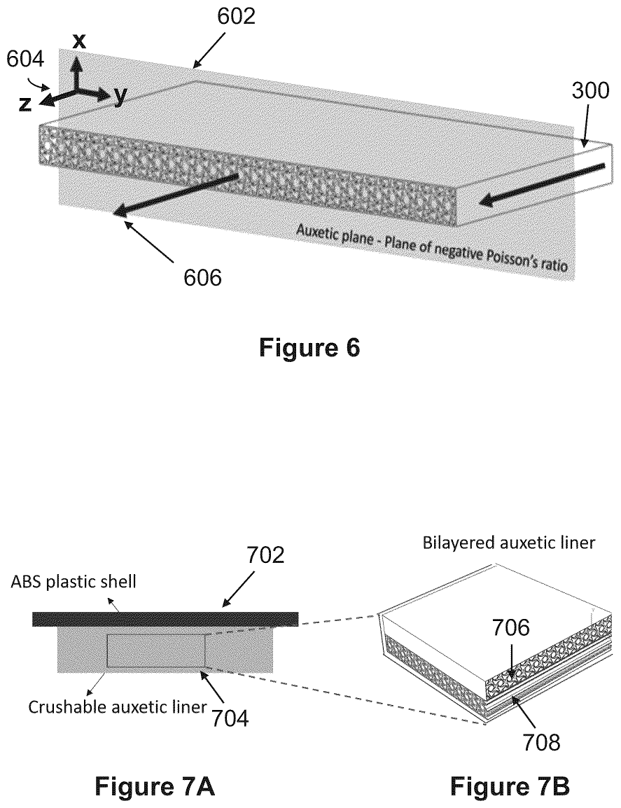

FIG. 6 shows the 3D auxetic structure 300 of FIG. 3 in accordance with an embodiment, where the 3D auxetic structure 300 has an auxetic plane 602 which exhibits auxetic behaviour (i.e. exhibits negative Poisson's ratio). The auxetic plane 602 is defined as an x-y plane in the Cartesian coordinates 604. Also shown in FIG. 6 is an auxetic structure axis 606, which is substantially perpendicular (or perpendicular (i.e. in the z-direction)) to the auxetic plane 602. Application of this auxetic structure 300 in a protective article for use in a head gear is described further below. An example of a head gear is a helmet.

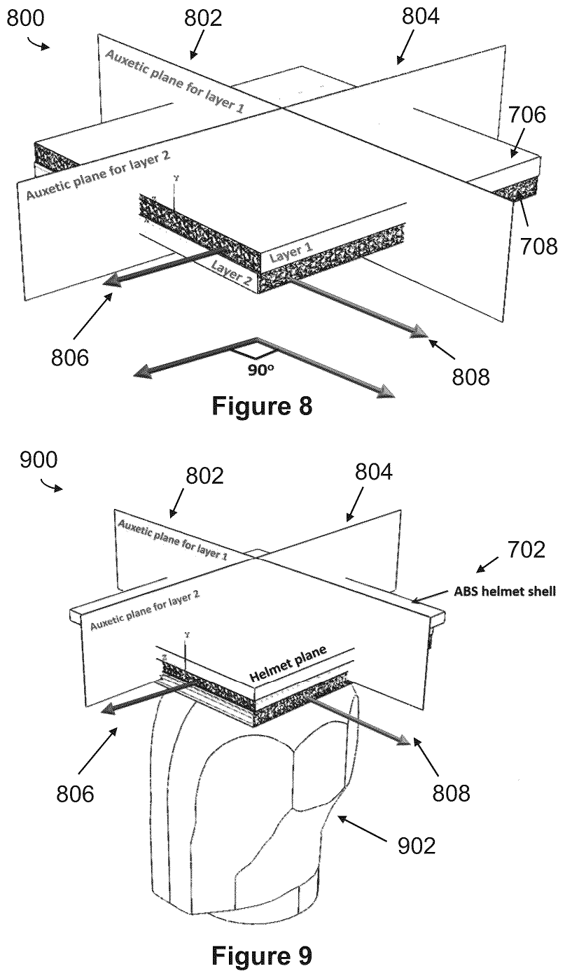

In the present embodiment, a protective article comprising two auxetic structures is applied in a head gear or helmet. FIG. 7A shows a cross-section of the head gear comprising an Acrylonitrile Butadiene Styrene (ABS) plastic shell 702 lined with a protective article 704 which is being used as a crushable auxetic liner in the head gear. A schematic of an enlarged perspective view of the protective article 704 is shown in FIG. 7B. As shown in FIG. 7B, the protective article 704 comprises two auxetic structures 706, 708 stacked adjacent to each other. Each of these auxetic structures 706, 708 includes the wavy chiral geometry as discussed in relation to FIG. 2. Also shown in FIG. 7B is that these auxetic structures 706, 708 are stacked in a mutually perpendicular direction on top of one another. In other words, the auxetic structure axes of each of these auxetic structures 706, 708 are perpendicular to each other. This is further illustrated in FIG. 8.

FIG. 8 shows a schematic 800 of the two auxetic structures 706, 708 stacked one on top the other to form the protective article 704 of FIG. 7A. A first auxetic plane 802 is defined for the top auxetic structure 706 and a second auxetic plane 804 is defined for the bottom auxetic structure 708. Each of these auxetic structures also has an auxetic structure axis, where the top auxetic structure 706 has a first auxetic structure axis 806 and the bottom auxetic structure 708 has a second auxetic structure axis 808 as shown in FIG. 8. The first auxetic structure axis 806 is perpendicular to the first auxetic plane 802, and the second auxetic structure axis 808 is perpendicular to the second auxetic plane 804. The first auxetic structure axis 806 is perpendicular to the second auxetic structure axis 808. As a consequence, the auxetic planes 802 and 804 are also perpendicular to each other.

FIG. 9 shows a schematic 900 of the protective article 704 when used as a liner in a helmet or a head gear in accordance with an embodiment. As shown in FIG. 9, the protective article 704 comprising the two auxetic structures 706, 708 forms a bilayered auxetic liner which is attached to a surface of the ABS helmet shell 702. The protective article is arranged so that the first and second auxetic structure axes 806, 808 of the protective article 704 are substantially parallel or parallel to a plane of the surface of the ABS helmet shell 702. Further, the auxetic planes 802, 804 of the two auxetic structures 706, 708 and the plane of the surface of the ABS helmet shell 702 are substantially orthogonal or orthogonal to one another. Also shown in FIG. 9 is a head-form 902 which shows an orientation of the ABS helmet shell 702 and the protective article 704 when used in a helmet or a head gear.

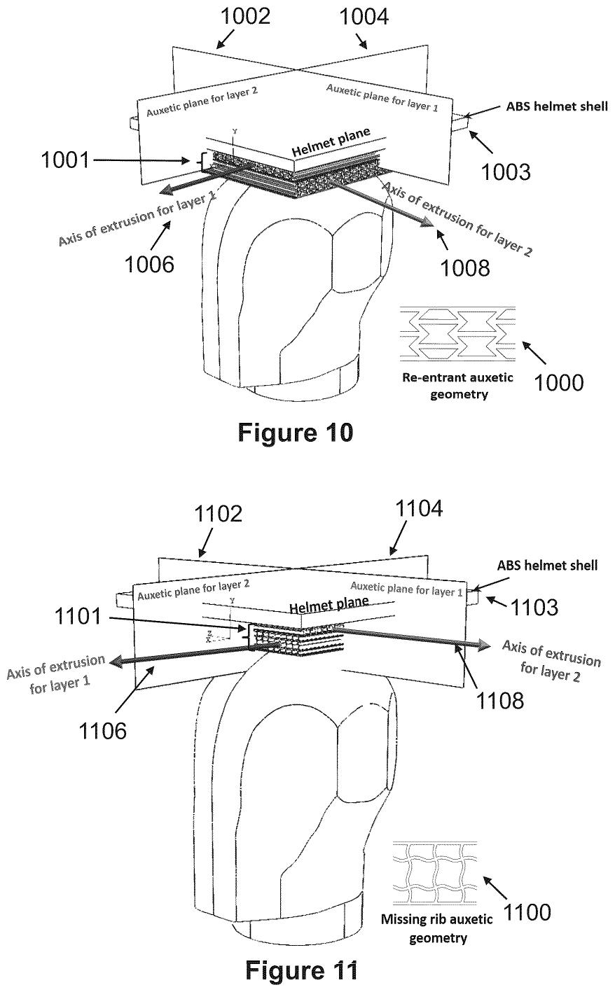

FIGS. 10 and 11 show alternative auxetic geometries which can be used in auxetic structures of a protective article.

FIG. 10 shows a schematic of a perspective view of a protective article used in a helmet or a head gear in accordance with an embodiment, where at least one auxetic structures of the protective article includes a re-entrant auxetic geometry 1000. Similar to FIG. 9, the protective article of FIG. 10 comprises a top auxetic structure (layer 1) stacked on top of, and adjacent to, a bottom auxetic structure (layer 2) to form a bilayered auxetic liner 1001. The bilayered auxetic liner 1001 is attached to a surface of an ABS helmet shell 1003. The top auxetic structure has an auxetic plane 1002 and the bottom auxetic structure has an auxetic plane 1004. Each of these auxetic planes 1002, 1004 exhibits auxetic behaviour (i.e. exhibits negative Poisson's ratio). Also shown in FIG. 10 are auxetic structure axes 1006 and 1008 for the top auxetic structure and the bottom auxetic structure, respectively. The auxetic structure axes 1006 and 1008 are each defined to be perpendicular to their respective auxetic planes 1002, 1004. The auxetic structure axis for the top auxetic structure 1006 and the auxetic structure axis for the bottom auxetic structure 1008 are also perpendicular to each other as shown in FIG. 10. Similar to the embodiment of FIG. 9, the bilayered auxetic liner 1001 is arranged so that the auxetic structure axes 1006, 1008 are each substantially parallel or parallel to a plane of the surface of the ABS helmet shell 1003. Further, the auxetic planes 1002, 1004 and the plane of the surface of the ABS helmet shell 1003 are substantially orthogonal or orthogonal to one another.

FIG. 11 shows a schematic of a perspective view of a protective article used in a helmet or a head gear in accordance with an embodiment, where at least one auxetic structures of the protective article includes a missing rib auxetic geometry 1100. Similar to FIGS. 9 and 10, the protective article of FIG. 11 comprises a top auxetic structure (layer 1) stacked on top of, and adjacent to, a bottom auxetic structure (layer 2) to form a bilayered auxetic liner 1101. The bilayered auxetic liner 1101 is attached to a surface of an ABS helmet shell 1103. The top auxetic structure has an auxetic plane 1102 and the bottom auxetic structure has an auxetic plane 1104. Each of these auxetic planes 1102, 1104 exhibits auxetic behaviour (i.e. exhibits negative Poisson's ratio). Also shown in FIG. 11 are auxetic structure axes 1106 and 1108 for the top auxetic structure and the bottom auxetic structure, respectively. The auxetic structure axes 1106 and 1108 are each defined to be perpendicular to their respective auxetic planes 1102, 1104. The auxetic structure axis of the top auxetic structure 1106 and the auxetic structure axis of the bottom auxetic structure 1108 are also substantially perpendicular or perpendicular to each other. Similar to the embodiment of FIGS. 9 and 10, the bilayered auxetic liner 1101 is arranged so that the auxetic structure axes 1106, 1108 are each substantially parallel or parallel to a plane of the surface of the ABS helmet shell 1103. Further, the auxetic planes 1102, 1104 and the plane of the surface of the ABS helmet shell 1103 are substantially orthogonal or orthogonal to one another.

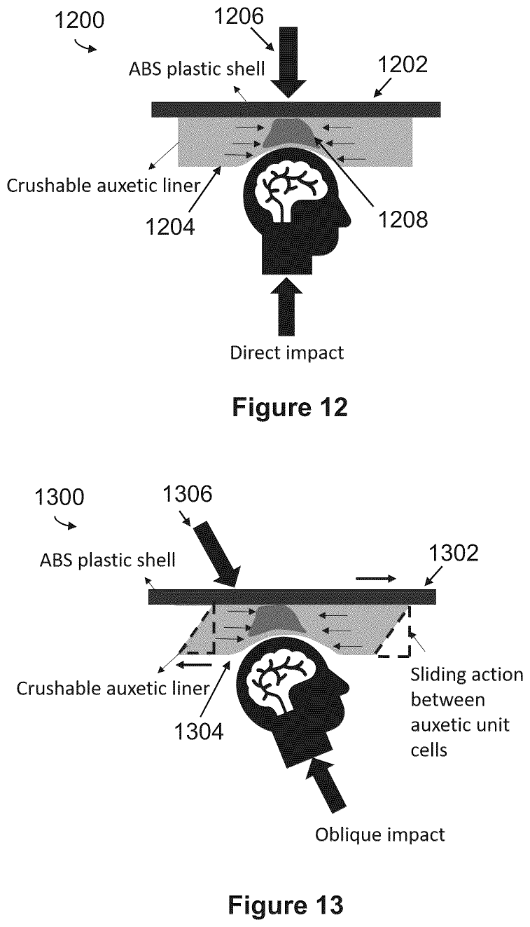

FIG. 12 shows a cross-section 1200 of a head gear comprising a protective article including auxetic structures in accordance with an embodiment during a direct impact. The head gear as shown in FIG. 12 comprises an ABS plastic shell 1202 and a crushable auxetic liner 1204, similar to the embodiments as discussed in relation to FIGS. 9, 10 and 11. During a direct impact 1206 where the impact is perpendicular to a surface of the helmet (or a surface of the ABS plastic shell 1202), the auxetic liner 1204 compresses in a direction perpendicular to the surface of the helmet to form a densest portion 1208 under the point of impact due to the auxetic nature of the auxetic liner 1204. This reduces a linear acceleration experienced by a user of the head gear during the direct impact 1206 considerably.

FIG. 13 shows a cross-section 1300 of a head gear comprising a protective article including auxetic structures in accordance with an embodiment during an oblique impact. Similar to FIG. 12, the head gear as shown in FIG. 13 comprises an ABS plastic shell 1302 and a crushable auxetic liner 1304. The auxetic liner 1304 can be from one of the embodiments discussed in relation to FIG. 9, 10 or 11. FIG. 13 illustrates partial deformation observed in a segment of the helmet during an oblique impact 1306. During an oblique impact 1306, unit cells or members of the auxetic structures slide relatively against one another, thereby absorbing a shear force/rotational force generated during the oblique impact 1306. This results in a reduction of a resultant rotational acceleration experienced by the user of the head gear of FIG. 13 as compared to that of a conventional helmet including EPS liners. This therefore significantly reduces a risk of TB's by the user of the head gear of FIG. 13 in the event of an oblique impact.

To validate the effectiveness of using auxetic liners in a head gear or helmet, direct impact and oblique impact tests were performed. In each of these impact tests, two identical helmets (i.e. in shape, size etc.) were used, except that one of the helmets was internally lined with conventional EPS crushable liners and the other of the helmets was internally lined with auxetic liners. The direct impact and oblique impact tests as shown in FIGS. 17 and 19, respectively, were performed on a helmet lined with single-layered auxetic liners. It should however be appreciated that a helmet lined with auxetic liners with a bilayered auxetic structure as shown in relation to FIGS. 9, 10 and 11 is expected to show similar or better results for these impact tests.

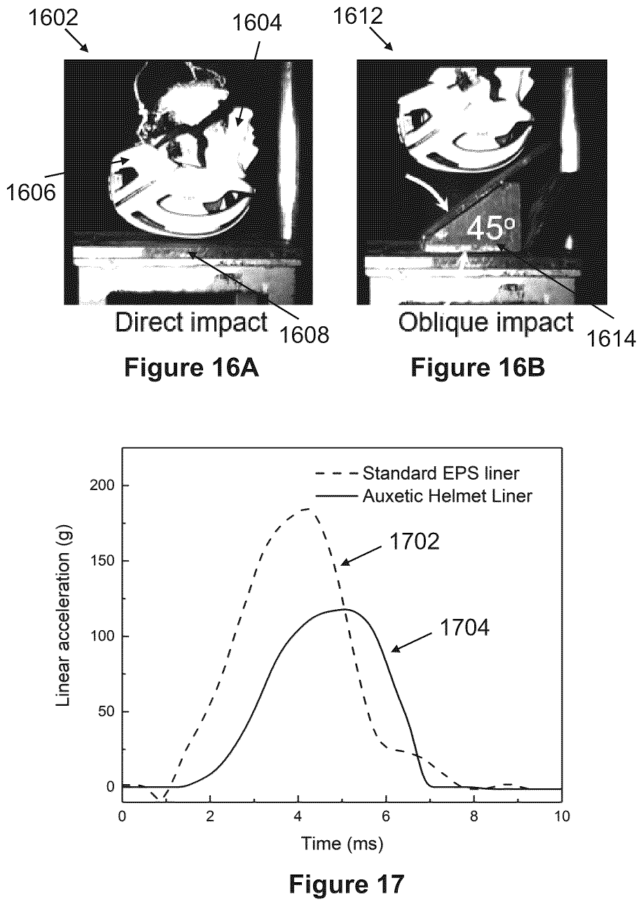

FIG. 14 shows an image 1400 of the helmet 1402 which was internally lined with auxetic liners 1404 in accordance with an embodiment. For these impact tests, the auxetic liners 1404 used were formed by 3D printing with a digital material (comprising Agilus and VeroWhite materials) using an Objet Connex 260 3D printer. The digital material used is a rubber-like plastic with a shore hardness of 60. The auxetic liners 1404 formed were then pasted to the inside of an ABS shell of the helmet 1402. There was no barrier layer or a slippery layer between the ABS shell and the auxetic liners 1404. A head-form was then placed in the helmet (see for examples images in relation to FIGS. 16A and 16B) such that the auxetic liners 1404 were in contact with the head-form. The helmet with the head-form was then used in performing the drop-tests using a drop-test set-up as shown in FIG. 15.

FIG. 15 shows an image 1500 of an experimental drop-test set-up 1502 used in performing direct impact tests and oblique impact tests on the helmets 1504 in accordance with an embodiment. In each of these impact tests, the helmets were fitted onto a head-form and dropped from a height of 2.3 m to be impacted on an anvil 1506, resulting in an impact velocity of 6.5 m/sec under free fall. The helmet-head-form assembly weighed a total of 5.6 kg.

FIGS. 16A and 16B show images 1602, 1612 of a helmet-head-form assembly undergoing the drop-tests in accordance with an embodiment. The helmet-head-form assembly comprises a head-form 1604 being secured in a helmet 1606 as exemplified in FIG. 16A. FIG. 16A shows the image 1602 of a direct impact drop-test during which the helmet 1606 impacted on a flat anvil 1604, while FIG. 16B shows the image 1612 of an oblique impact drop-test during which the helmet 1606 impacted on an angled anvil 1614.

For direct impact tests, the linear acceleration is measured using a tri-axis linear accelerometer (TE Connectivity Measurement Specialities, 832M1-0500) fixed at the centroid of the head-form 1604. For oblique impact tests, the helmet-head-form assembly was impacted on an angled anvil, inclined at an angle of 45° with the horizontal as shown in FIG. 16B. For an oblique impact, the head-form 1604 is subjected to rotational accelerations. In order to measure the rotational acceleration, the head-form 1604 is fitted with two tri-axis linear accelerometers, one placed at the centroid and the other placed at distances of 40 mm and 80 mm posterior to the centroid along the mid-sagittal plane. Upon an oblique impact, the rotational acceleration of the head-form 1604 about the direction normal to the mid-sagittal plane is measured using these two accelerometers by applying rigid-body kinematics. The acceleration data were acquired at a frequency of 4000 Hz.

FIG. 17 shows plots 1702, 1704 obtained experimentally from direct impact drop-test experiments using the helmet 1402 of FIG. 14 as well as a conventional helmet in accordance with an embodiment. The plot 1702 shows a linear acceleration versus time as experienced by a head-form in the conventional helmet, while the plot 1704 shows a linear acceleration versus time as experienced by a head-form in the helmet 1402 lined with auxetic liners. During a direct impact, owing to the auxetic properties of the crushable auxetic liners 1404, the auxetic liners 1404 absorb the impact energy significantly thereby reduces a linear acceleration experienced by the head-form. This is shown in the plots 1702 and 1704 where a 33% reduction in linear acceleration was observed as experienced by the head-form in the helmet 1402 lined with auxetic liners 1404 as compared to that for the head-form in the conventional helmet.

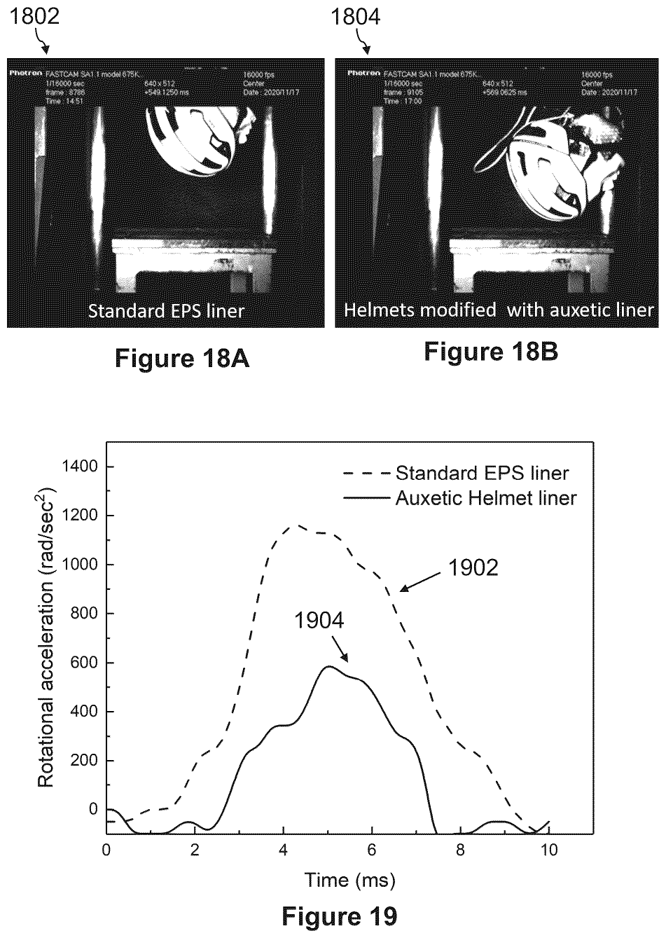

FIGS. 18A and 18B show images 1802, 1804 illustrating rebound heights of a conventional helmet and the helmet 1402 lined with auxetic liners 1404 in accordance with an embodiment. The rebound heights of the helmet-head form assemblies were measured to illustrate an amount of impact energy that was not depleted by the crushable liners of the helmets. FIG. 18A shows the image 1802 illustrating the rebound height of the conventional helmet after direct impact, while FIG. 18B shows the image 1804 illustrating the rebound height of the helmet 1402 lined with auxetic liners 1404 after direct impact. From FIGS. 18A and 18B, it is noted that the rebound height of the conventional helmet with standard EPS liners was twice that of the helmet modified with auxetic liners. This indicates that the impact energy is depleted more effectively by the auxetic liners as compared to the standard EPS liners.

FIG. 19 shows plots 1902, 1904 obtained experimentally from oblique impact drop-test experiments using the helmet 1402 of FIG. 14 as well as a conventional helmet with standard EPS liners in accordance with an embodiment. The plot 1902 shows rotational acceleration versus time as experienced by a head-form in the conventional helmet, while the plot 1904 shows rotational acceleration versus time as experienced by a head-form in the helmet 1402 lined with auxetic liners 1404. During an oblique impact, the relative sliding observed between the auxetic unit cells allows for the head-form to slide inside the helmet 1402, thereby reducing the rotational acceleration experienced by the head-form significantly. As shown by the plots 1902, 1904, during an oblique impact, the rotational acceleration experienced by the head-form fitted into the helmet 1402 modified with auxetic liners 1404 was 50% less as compared to the head-form fitted into the conventional helmet with standard EPS liners. This indicates that the sliding between the auxetic unit cells of the auxetic structures in the auxetic liners offer cushioning against rotational acceleration upon an oblique impact.

Although the wavy hexachiral geometry was used in the auxetic structures of the protective article as described in the above embodiments, other auxetic geometry that exhibits auxetic behaviour in an auxetic plane (e.g. the x-y plane) may be used. FIGS. 20A, 20B, 20C, 20D, 20E and 20F show illustrations of different auxetic geometries that exhibit auxetic behaviour in an x-y plane in accordance with embodiments. For each of these auxetic geometries, both a three-dimensional representation and a two-dimensional representation (in the x-y plane) are shown (except for the missing rib hexachiral geometry of FIG. 20B where only the three-dimensional representation is shown). Each of these three-dimensional structures are drawn with reference to the Cartesian coordinates 2001, while the corresponding x-y plane 2003 is also shown as reference to the two-dimensional representation.

FIG. 20A shows a three-dimensional triangle geometry structure 2002 with a corresponding two-dimensional representation 2004. FIG. 20B shows a three-dimensional missing rib hexachiral geometry structure 2006. FIG. 20C shows a three-dimensional missing rib anti-tetra chiral geometry structure 2008 with a corresponding two-dimensional representation 2010. FIG. 20D shows a three-dimensional straight chiral geometry with a corresponding two-dimensional representation 2014. FIG. 20E shows a three-dimensional wavy chiral geometry structure 2016 with a corresponding two-dimensional representation 2018. FIG. 20F shows a three-dimensional re-entrant geometry structure 2020 with a corresponding two-dimensional representation 2022.

When constructed as a panel or a block, three dimensional structures of the aforementioned auxetic geometries are extruded in the out-of-plane (Z) direction. As shown in FIGS. 20A to 20F, the cross-section in the x-y plane of each of these three-dimensional structures remains the same in the out-of-plane (z) direction. While these auxetic structures with a constant cross-section can be formed using additive manufacturing such as 3D printing, industrially manufacturing these structures can be a challenge. In particular, these auxetic structures are difficult to be industrially manufactured using an extrusion or injection moulding process, owing to a complexity of the geometries and other Design for Manufacturing (DFM) requirements. This also applies to the three-dimensional structure formed using the wavy hexachiral auxetic geometry 200 described in relation to FIGS. 2 to 6 above.

FIGS. 21A to 24C illustrate the difficulties that may be experienced in forming a constant cross-section auxetic structure by injection moulding. In these Figures, a honey-comb structure was used as an example.

FIGS. 21A and 21B show schematics of a honey-comb structure 2102 proposed to be formed by injection moulding in accordance with an embodiment. FIG. 21A shows a perspective view of the three-dimensional honey-comb structure 2102, while FIG. 21B shows a cross-sectional view 2104 of the three-dimensional structure 2104 (i.e. an x-y plane of the honey-comb structure 2102). In the present embodiment, each of the ligaments 2106 of this honey-comb structure 2102 has a constant thickness of 0.4 mm in the out-of-plane direction (i.e. the z-direction).

FIGS. 22A and 22B shows schematics of a casting die tool 2202 used in injection moulding for forming the three-dimensional honey-comb structure 2102 of FIG. 21A in accordance with an embodiment. FIG. 22A shows a perspective view of the casting die tool 2202 and FIG. 22B shows an internal structure 2204 of the casting die tool 2202. In order to form the honey-comb structure 2102 by injection moulding, material for forming the honey-comb structure 2102 is provided in the casting die tool 2202. In the present embodiment where the honey-comb structure is formed by a polymer, a hot molten polymer is injected into the hard steel casting die tool 2202 at high pressure. Once this hot molten polymer is cured and hardened, the formed honey-comb structure in the casting die tool 2202 is then ejected out (or the casting die tool 2202 is ejected from the formed honey-comb structure) to retrieve the honey-comb structure 2102 of FIG. 21A. However, ejecting the formed honey-comb structure 2102 from the casting die tool 2202 is not straight-forward as the polymer material of the formed honey-comb structure 2102 tends to stick to surfaces of the casting die tool 2204 and therefore hinders the ejection. Forcefully ejecting the formed honey-comb 2102 on the other hand may result in tearing of the ligaments 2106.

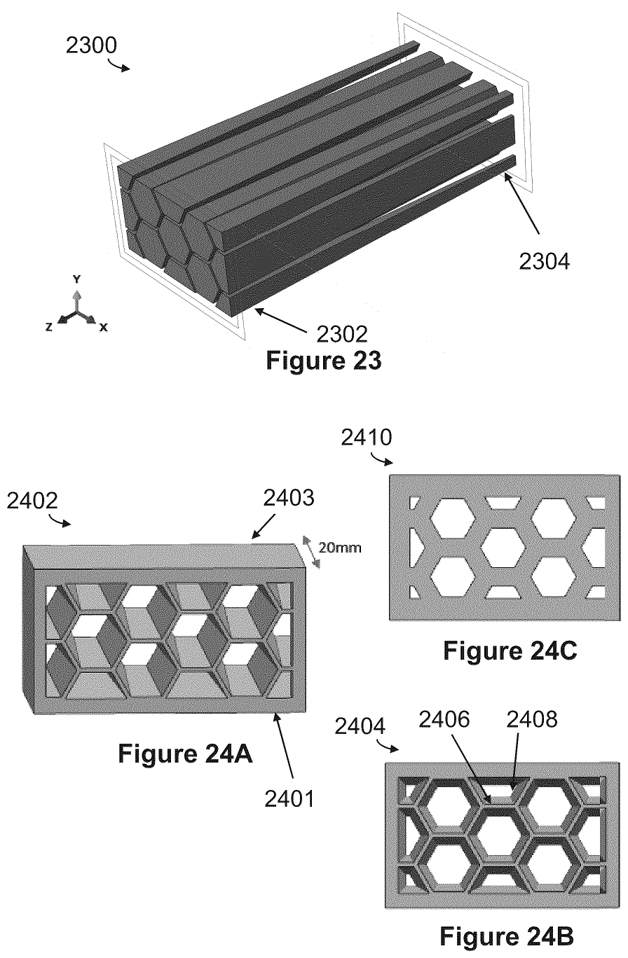

FIG. 23 shows an internal structure of a casting die tool 2300 that is made suitable for ejecting formed honey-comb structure by injection moulding in accordance with an embodiment. As shown in FIG. 23, a draft angle of 2° has been introduced in the casting die tool 2300, making the casting die tool or mould tapered from a proximal end 2302 to a distal end 2304 along the out-of-plane direction (or the z-direction). This facilitates easier ejection of the formed honey-comb structure from the casting die tool 2300. However, there are limitations of this solution and this is illustrated by FIGS. 24A, 24B and 24C below.

FIGS. 24A, 24B and 24C show illustrations of a final product of a three-dimensional honey-comb structure formed by injection moulding using the casting die tool 2300 of FIG. 23 in accordance with an embodiment. FIG. 24A shows a perspective view of the formed honey-comb structure 2402, FIG. 24B shows a cross-sectional view 2404 from a proximal end 2401 of the three-dimensional honey-comb structure 2402, and FIG. 24C shows a cross-sectional view 2410 from a distal end 2403 of the three-dimensional honey-comb structure 2402. As a result of the 2° draft angle of the casting die tool 2300, ligaments of the formed honey-comb structure 2402 do not have a constant thickness across the depth of this honey-comb structure 2402 (i.e. along the out-of-plane or z-direction as shown in FIG. 23). Referring to the example honeycomb structure 2402 formed using the casting die tool 2300, a thickness of ligaments is 0.4 mm on the proximal end 2401 of the structure 2402 but it increases in the out-of-plane direction towards the distal end 2403 of the structure 2402 as shown in FIG. 24C. In the present embodiment, a thickness of the ligaments increases from 0.4 mm at the proximal end 2401 to 1.8 mm at the distal end 2403 for a depth of 20 mm. This increase in thickness is undesirable as it increases the weight of the structure formed, and affects a safety performance of auxetic liners formed using such uneven structures.

FIG. 25 shows a perspective view of a three-dimensional hexachiral auxetic structure 2500 having a constant ring radius in accordance with an embodiment. This three-dimensional hexachiral auxetic structure shows a constant cross-section 2502 in the out-of-plane direction, similar to the structures as shown in FIGS. 20A to 20F, and will encounter similar problems as discussed in relation to FIGS. 21A to 24C above if they are to be formed by injection moulding. To resolve these problems associated with injection moulding, the following auxetic structures in relation to FIGS. 26 and 28 are proposed.

FIG. 26 shows a perspective view of a three-dimensional hexachiral auxetic structure 2600 in accordance with an embodiment. The auxetic structure 2600 comprises a plurality of interconnected auxetic members, with each auxetic member having a varying ring radius along a direction of the auxetic structure axis 2601 (i.e. in an out-of-plane direction or a z-direction where an auxetic plane of the auxetic structure 2600 is in the x-y plane). In other words, each member of the auxetic structure 2600 has a varying cross-section in the direction of the auxetic structure axis 2601. Referring to an exemplary member 2602 of the auxetic structure 2600, it is shown that a body of the member 2602 extends along the auxetic structure axis and tapers linearly from a proximal end 2604 to a distal end 2606. In other words, a radius of the ring of the member 2602 decreases from the proximal end 2604 to the distal end 2606. As shown in FIG. 26, auxetic members in adjacent rows 2608, 2610 (i.e. a top row 2608 and a bottom row 2610) with respect to the member 2602 are arranged in opposite relations to the member 2602. Each of the auxetic members in these adjacent rows 2608, 2610 therefore has a body 2611 that tapers in an opposite direction as compared to that of the member 2602. To put it in another way, if one is to define each auxetic member of the auxetic structure 2600 to have a tapered body that tapers from its proximal end to its distal end, then adjacent auxetic members 2612, 2614, 2616, 2618 of the adjacent rows 2608, 2610 are arranged such that distal ends of these auxetic members 2612, 2614, 2616, 2618 are arranged adjacent to the proximal end 2604 of the auxetic member 2602.

By having the auxetic members arranged as shown in FIG. 26 so that members of adjacent rows taper in an opposite direction to one another (e.g. large rings and small rings are placed alternatively in an x-z plane when viewed from an x-y plane at one end of the auxetic structure), this allows the drafting requirements of the casting die tool for injection moulding to be incorporated in the design of the auxetic structure. The proposed auxetic structure therefore facilitates easy ejection of the formed auxetic structure by injection moulding. In some embodiments, constant thicknesses for rings and/or ligaments of the auxetic structure may be maintained. Having the body of the rings and/or ligaments (e.g. each auxetic member) tapering from the proximal end to the distal end with a constant thickness may be desirable because this may ensure that a weight distribution and a safety performance of the auxetic structure is maintained when used in a protective article. This may also ease a design complexity of these auxetic structures when used in a protective article for impact absorption, and may overcome the issues of uneven thicknesses as described in relation to FIGS. 23 to 24C above. This paves the way for potential mass manufacturing of such auxetic structures using injection moulding processes, which is important if these auxetic structures are to be used in protective articles in a large scale. Although a method of forming an auxetic structure using injection moulding is described, it will be appreciated by a skilled person that the above also provides for a method of forming a protective article (e.g. a protective article comprising a bilayered auxetic structure) since once each layer or auxetic structure is formed, these auxetic structures can be connected together to form the desired protective article. In an embodiment, different auxetic structures of the protective article can also be formed in a single injection moulding process by using an appropriate casting die mould.

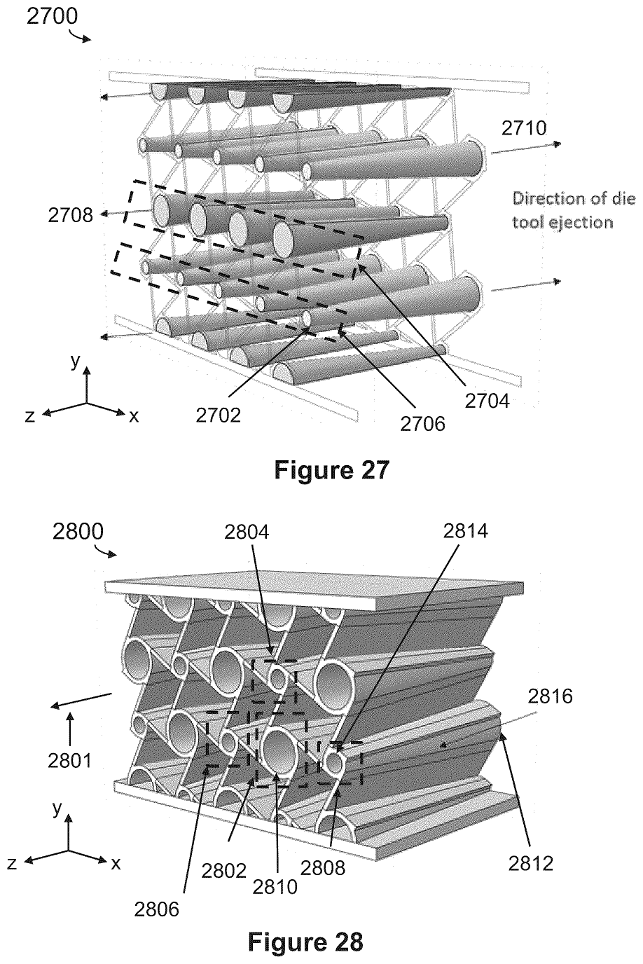

FIG. 27 shows a perspective view 2700 of portions of a casting die tool used in injection moulding for forming the three-dimensional hexachiral auxetic structure 2600 of FIG. 26 in accordance with an embodiment. As shown in FIG. 27, a start 2702 of the draft for each feature of the casting die tool alternates in an opposite direction between adjacent rows. For example, as shown in FIG. 27, the draft of each features of the casting die tool in row 2704 is in an opposite relation to the draft of each features of the casting die tool in row 2706. As a result, the draft requirement is incorporated into the design of the auxetic structure 2600. Also shown in FIG. 27 are the directions 2708, 2710 of die tool ejection once the auxetic structure 2600 is formed by injection moulding. In the present embodiment, the tapered alternating features of the casting die tool are ejected in opposite direction along the auxetic structure axis (or the z-axis) to form the auxetic structure 2600 by injection moulding.

FIG. 28 shows a perspective view of a three-dimensional tetrachiral auxetic structure 2800 with each member of the auxetic structure 2800 having a varying ring radius in a direction of the auxetic structure axis 2801 (or z-axis). As shown in FIG. 28, alternating auxetic members of the auxetic structure 2800 have bodies which taper in an opposite direction in relation to one another. Similar to FIG. 26, if one is to define each auxetic member of the auxetic structure 2800 to have a tapered body that tapers from its proximal end to its distal end, using a reference member 2802, then its adjacent auxetic members such as members 2804, 2806, 2808 are arranged such that the distal ends of these auxetic members 2804, 2806, 2808 are adjacent to the proximal end 2810 of the auxetic member 2802. To clarify, it is shown in FIG. 28, a proximal end 2812 and a distal end 2814 of the auxetic member 2808 which has a body 2816 that tapers from the proximal end 2812 to the distal end 2814, and which is arranged in an opposite relation to that of the auxetic member 2810.

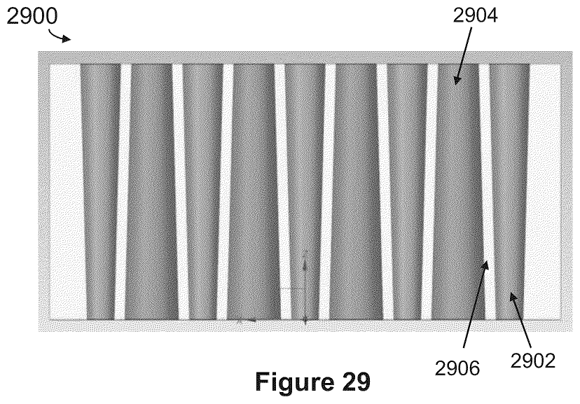

FIG. 29 shows a top cross-sectional view 2900 of the portions of the casting die tool used in injection moulding for forming the three-dimensional tetrachiral auxetic structure 2800 in accordance with an embodiment. As shown in FIG. 29, feature 2902 and feature 2904 of the casting die tool are arranged so that feature 2902 and feature 2904 tapers in an opposite direction to each other, in a complementary manner to the corresponding members of the tetrachiral auxetic structure 2800. By alternating a start of the draft for each features of the die tool in this manner, the features of the die with opposite relations (e.g. features 2902 and 2904) can be seamlessly ejected in opposite directions, thereby easing the ejection process.

Although two proposed structures are described above in relation to FIGS. 26 and 28, these are exemplary and it should be appreciated that structures having other auxetic geometries may be possible, as long as the draft requirement of injection moulding is satisfied. This may be achieved, for example, by having a structure where at least some adjacent auxetic members are arranged in opposite relations in which a distal end of one auxetic member is arranged adjacent to a proximal end of an adjacent auxetic member. Further, it should be appreciated that ejecting the features of the die with opposite relations in opposite directions may also include ejecting these features at an angle to each other where the angle is not necessarily 180°. In some embodiments, these features may be ejected at an angle, α, in a range of 90°<α<180°, or 120°≤α≤180°, or 150°≤α≤180° or α=180° or substantially 180°.

Alternative embodiments of the invention include: (i) a first auxetic structure axis of a first auxetic structure and a second auxetic structure axis of a second auxetic structure comprised in a protective article are in a non-parallel relation (i.e. an angle θ between the first auxetic structure axis and the second auxetic structure axis has a range of 0°<θ<180°, or 30°≤θ≤150°, or 60°≤θ≤120° or θ=90° or substantially 90°); (ii) an auxetic structure axis of an auxetic structure being an axis of extrusion if the auxetic structure is formed by an extrusion process; (iii) a first auxetic structure and a second auxetic structure comprised in a protective article being of different auxetic geometries; (iv) a first auxetic structure and a second auxetic structure comprised in a protective article being made of different auxetic materials and/or of different compositions; (v) a protective article comprising an auxetic structure as described in any one of the preceding embodiments; (vi) a fuel tank comprising a protective article of any one of the preceding embodiments; (vii) a protective article for lining a surface of a fuel tank for protecting the fuel tank from external impacts; (viii) an auxetic structure where at least some adjacent auxetic members are arranged so that auxetic members in a column are in opposite relations to auxetic members in adjacent columns; and (ix) the body of at least some auxetic members of an auxetic structure tapers from a proximal end to a distal end in a non-linear manner.

Although only certain embodiments of the present invention have been described in detail, many variations are possible in accordance with the appended claims. For example, features described in relation to one embodiment may be incorporated into one or more embodiments and vice versa.

1. A protective article comprising auxetic structures, the auxetic structures including:
a first auxetic structure having a first auxetic plane exhibiting auxetic behaviour and a first auxetic structure axis, the first auxetic structure axis being substantially perpendicular to the first auxetic plane; and
a second auxetic structure having a second auxetic plane exhibiting auxetic behaviour and a second auxetic structure axis, the second auxetic structure axis being substantially perpendicular to the second auxetic plane,
wherein the second auxetic structure axis is arranged in a non-parallel relationship to the first auxetic structure axis.

2. The protective article of claim 1, wherein the first auxetic structure axis is an axis of extrusion of the first auxetic structure, and the second structure axis is an axis of extrusion of the second auxetic structure or wherein the first auxetic structure axis is perpendicular to the second auxetic structure axis.

3. (canceled)

4. The protective article of claim 1, wherein the first auxetic structure and the second auxetic structure are made of different auxetic geometries or are made of different material compositions.

5. (canceled)

6. The protective article of claim 1, wherein the first auxetic structure and the second auxetic structure each comprises an auxetic geometry selected from a wavy chiral geometry, a re-entrant auxetic geometry, or a missing rib auxetic geometry.

7. A head gear comprising the protective article of claim 1.

8. The head gear of claim 7, wherein the protective article is adapted to line an interior of the head gear so that the first auxetic plane of the first auxetic structure and the second auxetic plane of the second auxetic structure are perpendicular to an outer surface of the head gear.

9. A fuel tank comprising the protective article of claim 1.

10. An auxetic structure for use in a protective article, the auxetic structure having an auxetic plane exhibiting auxetic behaviour and an auxetic structure axis, the auxetic structure axis being substantially perpendicular to the auxetic plane, the auxetic structure comprising a plurality of interconnected auxetic members, each auxetic member having a body extending along the auxetic structure axis, the body tapering from a proximal end to a distal end, wherein at least some adjacent auxetic members are arranged in opposite relations in which a distal end of one auxetic member is arranged adjacent to a proximal end of an adjacent auxetic member.

11. The auxetic structure of claim 10, wherein the at least some adjacent auxetic members are arranged so that auxetic members in a row are in opposite relations to auxetic members in adjacent rows.

12. The auxetic structure of claim 10, wherein the at least some adjacent auxetic members are arranged so that auxetic members in a column are in opposite relations to auxetic members in adjacent columns.

13. The auxetic structure of claim 10, wherein the at least some adjacent auxetic members are arranged so that alternating adjacent auxetic members are in opposite relations to each other.

14. The auxetic structure of claim 10, wherein the body of each auxetic member tapers linearly from the proximal end to the distal end.

15. The auxetic structure of claim 14, wherein the body of each auxetic member tapers at a draft angle of 2°.

16. The auxetic structure of claim 10, wherein the auxetic structure is selected from a tetrachiral geometry or a hexachiral geometry.

17. A method for forming the auxetic structure of claim 10 by injection moulding.

18. The method of claim 17, wherein injection moulding comprises:
providing material for forming the auxetic structure in a die, the die having tapered features arranged in opposite relations for forming the at least some adjacent auxetic members of the auxetic structure; and
ejecting the tapered features of the die in opposite directions to form the auxetic structure.

19. A protective article comprising the auxetic structure of claim 10.

20. A head gear comprising the protective article of claim 19.

21. The head gear of claim 20, wherein the protective article is adapted to line an interior of the head gear so that the auxetic plane of the auxetic structure is perpendicular to an outer surface of the head gear.

22. A fuel tank comprising the protective article of claim 19.
